(19) United States
(12) Patent Application Publication
(10) Pub. No.: US 2021/0042799 A1
(43) Pub. Date: Feb. 11, 2021

(54) SYSTEM FOR EMPOWERING CONSUMERS TO ACHIEVE THEIR DREAMS AND ASPIRATIONS THROUGH SOCIAL NETWORKING WITH AN INTEGRATED DECENTRALIZED MARKETPLACE TO FACILITATE THE TRUSTLESS EXCHANGE OF SERVICES, AND CROWDFUNDING CAPABILITIES

(71) Applicants: Chris Adams, Las Vegas, NV (US); Ashish Bagrecha, Las Vegas, NV (US)

(72) Inventors: Chris Adams, Las Vegas, NV (US); Jaime Morgan, Las Vegas, NJ (US); Ashish Bagrecha, Las Vegas, NJ (US)

(21) Appl. No.: 16/533,573

(22) Filed: Aug. 6, 2019

(51) Int. Cl. G06Q 30/02; G06Q 50/00

(52) U.S. Cl. CPC G06Q 30/0279; G06Q 2220/00; G06Q 50/01

(57) ABSTRACT

A computer implemented method of communicating between devices is disclosed. The computer implemented method includes: transmitting at least one dream request to a specialized program on a dreamr server; receiving the at least one dream request at the dreamr server; determining if the at least one dream request invites a first group of registered users to co-dream with the at least one dream request; forming a supportive network if the at least one dream request invites the first group of registered users; determining if the supportive network invites a second group of registered users to co-dream; initiating dreamweaving between the supportive network and the second group of registered users if the supportive network invites the second group of registered users to co-dream and become a supernetwork; and enabling the supernetwork and the second group of registered users to become monetized, wherein goods and services of the supernetwork and the second group of registered users are marketed at a marketplace.

### FIELD OF THE INVENTION

The present invention relates to a system for empowering consumers to achieve their dreams and aspirations through social networking tools, an integrated decentralized marketplace to facilitate the trustless exchange of services, and crowdfunding capabilities.

### BACKGROUND OF THE INVENTION

Generally, everyone has a dream of who they would like to become or what they would like to achieve. A dream is often looked upon as being something that may or may not be achievable, such as a new car, a new house, starting a business, creating a better life for you or your family. In the current time, consumers can utilize social networking tools such as Facebook™, Instagram™, LinkedIn™, as well as other popular social networking websites to share their dream, thoughts, comments and points of view with consumers throughout the world. Additionally, consumers can use crowdfunding sites like Kickstarter and Indiegogo to fund their ambitions. However, the current paradigm of social media has made it possible for people to easily share false and exaggerated versions of themselves online. Additionally, the way users engage with user generated content (superficial likes and comments) does very little to facilitate genuine connections. The current paradigm of crowdfunding supports investment in ideas rather than people and provides no transparent way to ensure money raised is being used for its stated purpose. Additionally, there is no current Marketplace that allows users to conduct transactions Peer to Peer on a contractual basis, enabling the trustless execution of Service-for-Money or Service-for-Service trades.

Therefore, there is a need for consumers to genuinely connect with each other through social networking that will be meaningful and engaging. There is also a need for a platform that nurtures ideas and dreams intro fruition with tools and resources designed to help users progress.

### SUMMARY OF THE INVENTION

The present invention has been accomplished in view of the above-mentioned technical background, and it is an object of the present invention to provide a computerized system for creating a dream achievement ecosystem.

In a preferred embodiment of an invention, a computer implemented method of communicating between devices is disclosed. The computer implemented method includes: transmitting at least one dream request to a specialized program on a dreamr server; receiving the at least one dream request at the dreamr server; determining if the at least one dream request invites a first group of registered users to co-dream with the at least one dream request; forming a supportive network if the at least one dream request invites the first group of registered users; determining if the supportive network invites a second group of registered users to co-dream; initiating dreamweaving between the supportive network and the second group of registered users if the supportive network invites the second group of registered users to co-dream and become a supernetwork; and enabling the supernetwork and the second group of registered users to become monetized, wherein goods and services of the supernetwork and the second group of registered users are marketed at a marketplace

### BRIEF DESCRIPTION OF THE DRAWINGS

These and other advantages of the present invention will become more apparent as the following description is read in conjunction with the accompanying drawings, wherein:

FIG. 1 shows a schematic representation of communication between a first device, a dreamr platform and a decentralized network in accordance with the invention;

FIG. 2A is a flow chart of how the first device interacts with the dreamr platform in accordance with the invention;

FIG. 2B is a continuation of the flow chart of FIG. 2A that shows how the first device interacts with the dreamr platform in accordance with the invention;

FIG. 3 shows an example of a screen shot of the HOME Screen of the dreamr software application of the dreamr platform in accordance with the invention;

FIG. 4 shows an example of screenshots of Declare your dream in accordance with the invention;

FIG. 5. shows an example of screenshots of DreamConnect in accordance with the invention;

FIG. 6 show examples of screen shots of DreamWeaving in accordance with the invention;

FIG. 7 show an example of a screenshot of Marketplace in accordance with the invention;

FIG. 8 show examples of screenshots of Messenger in accordance with the invention;

FIG. 9 show an example of a screenshot of Crowdfunding in accordance with the invention; and

FIG. 10 shows an example of a screenshot of an Integrated Digital Wallet in accordance with the invention.

### DETAILED DESCRIPTION OF THE INVENTION

The presently preferred embodiments of the invention are described with reference to the drawings, where like components are identified with the same numerals. The description of the preferred embodiments are exemplary are and are not intended to limit the scope of the invention.

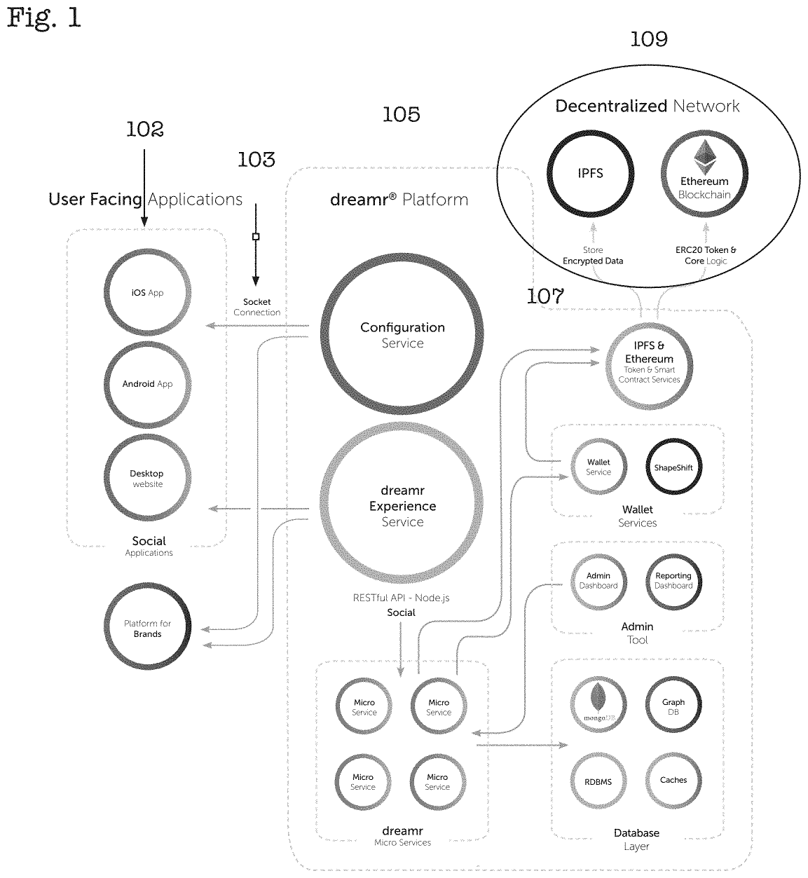

FIG. 1 shows a schematic representation of communication between a first device, a dreamr platform and a decentralized network. A dreamr communication system 100 includes: a first device 101, a first web interface 103, a dreamr platform 105, a second web interface 107 and a decentralized network 109. First device 101 is connected through a communication link, such as web Interface 103 to the dreamr platform 105. Dreamr platform 105 is connected through a communication link second web interface 107 to the decentralized network 109. The communication link for the first web interface 103 and second web interface 107 may be a local access network (LAN), wireless access network, wide area network (WAN), a virtual area network, wireless fidelity (Wi-Fi) network, Bluetooth, an Ethernet link, a satellite link, cable link, cellular, fiber-optic or any network that can facilitate the transfer of information between computer systems. The first device 101 includes an actual person/consumer that utilizes the first device 101. First device 101 includes user input devices that provide a portion of a user interface. The user input devices may include one or more microphones, a touch screen, an alphanumeric keypad, such as a keyboard, for inputting alpha-numeric and other information, or a pointing device, such as a mouse, a trackball, stylus, or cursor direction keys. First device 101, and the dreamr platform 105 may be any type of computer system including a desktop, laptop, notebook, mobile computer system, a tablet computing system, cell phone, smartphone, mobile phone or any type of computing system with the standard input systems of a touchscreen, mouse, etc. First device 101 may be an iPhone having and IOS app operating system or an Android phone having an Android operating system.

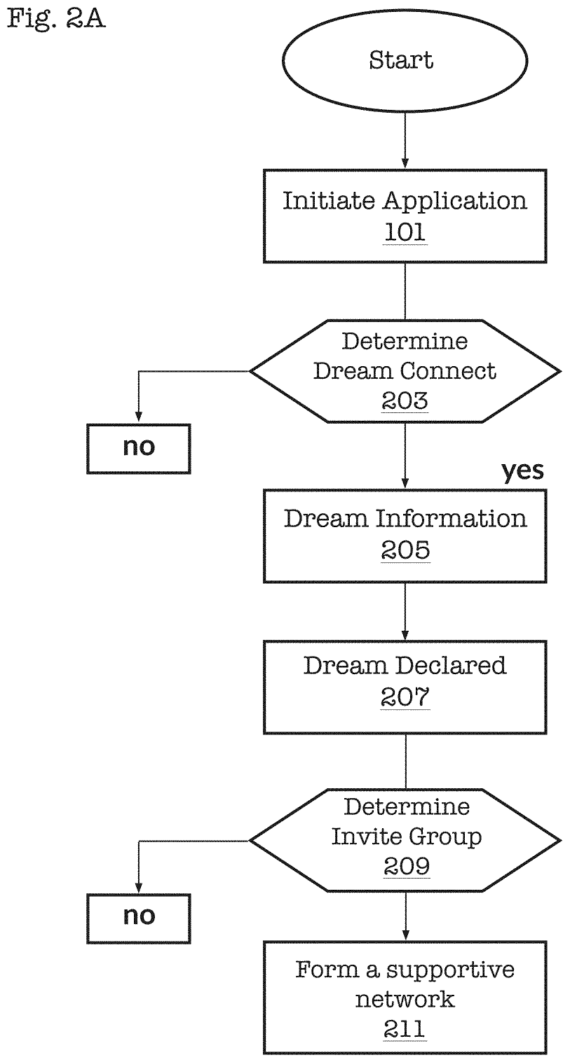

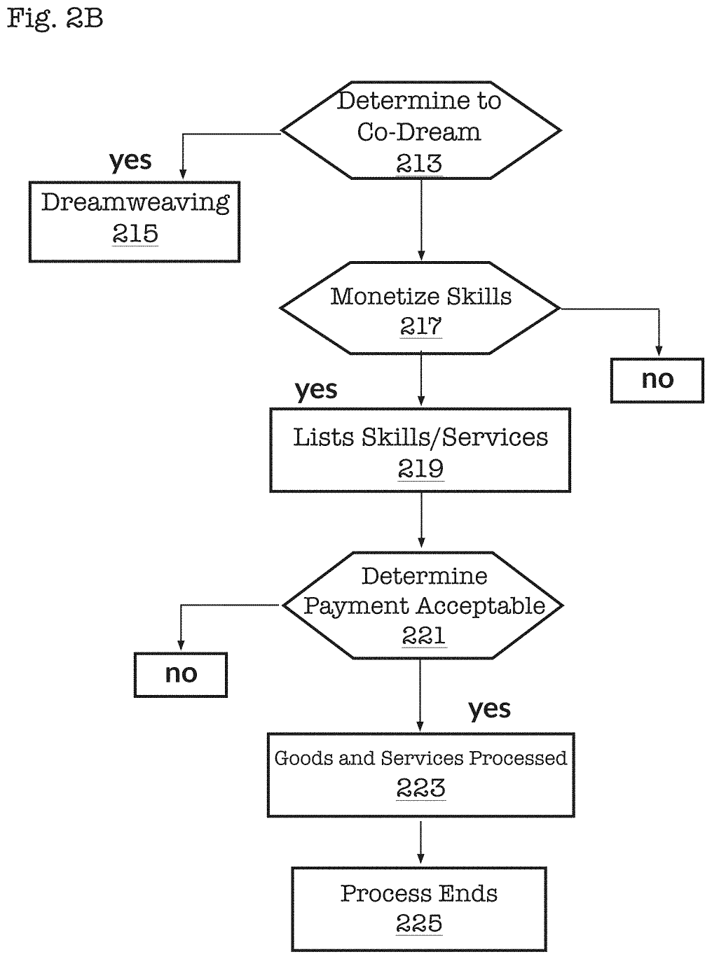

Dreamr platform 105 or dreamr server 105 may also be referred to as the dreamr server. The dreamr server 105 is equivalent to a typical server or computer system that includes a processor, mass storage and memory. The dreamr server 105 also includes a special application program or algorithm stored on the processor or mass storage which will be described in FIGS. 2A and 2B. The term “dreamr” represents software application program, which is stored on the storage and/or processer of the dreamr platform or dreamr server that allows a registered dreamr by using the dreamr software application to transfer his dreams to the dreamr platform for social networking and utilization on the dreamr communication system 100 or dreamr ecosystem. Typical software programs are a set of programs, procedures, algorithms and documentation which are integral to the operation of a data processing system. First device 101 and dreamr server 105 are typical computers that may include bus configurations, networked platforms, etc. Various operating systems may be used including Unix, Linux, Windows, Mac OS, Palm OS, Android, iOS (known as iPhone OS before June 2010), QNX, and other suitable operating systems. It is noteworthy that any hardware platform suitable for performing the processing describe herein is suitable for use with the embodiments provided herein. Computer-readable storage media refer to a medium or media that participate in providing instructions to a central processing unit (CPU), a processor, a microcontroller, or the like. Such media may take forms including, but not limited to non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), Blu-ray Disc, any other optical storage medium, RAM, PROM, EPROM, EEPROM, FLASH memory, and/or any other memory chip, module or cartridge.

The decentralized network 109 is composed of the Interplanetary File System (IPFS) or the Ethereum block chain. However, other distributed file systems and blockchains can be utilized if they are deemed to be better suited. Or, similarly, another type of blockchain may be developed in the future.

The IPFS is a peer-to-peer distributed filed system that seeks to connect all computing devices with the same system of files. (https://ipfs.io/) In some ways, IPFS is similar to the Web, but IPFS could be a single Bit Torrent swarm, exchanging objects within one Git repository. In other words, IPFS provides a high throughput content-addressed block storage model, with content addressed hyperlinks. This forms a generalized Merkle DAG, a data structure upon which one can build versioned file systems, blockchains and even a permanent Web. IPFS combines a distributed hash table, an incentivized block exchange, and a self-certifying namespace. IPFS has no single point of failure, and nodes do not need to trust each other.

IPFS nodes communicate regularly with hundreds of other nodes in the network, potentially across the wide Internet. But other distributed file systems can be utilized or developed if they are deemed to be better suited for the dreamr platform.

The IPFS network stack features: Transport: IPFS can use any transport protocol and is best suited for WebRTC Data Channels [?] (for browser connectivity) or uTP(LEDBAT [14]). Reliability: IPFS can provide reliability if underlying networks do not provide it, using uTP (LEDBAT [14]) or SCTP [15]. Connectivity: IPFS also uses the ICE NAT traversal techniques [13]. Integrity: optionally checks integrity of messages using a hash checksum. Authenticity: optionally checks authenticity of messages using HMAC with sender's public key.

The Ethereum blockchain is a decentralized platform that runs smart contracts: applications that run exactly as programmed without any possibility of downtime, censorship, fraud or third-party interference. These apps run on a custom built blockchain an enormously powerful shared global infrastructure that can move value around and represent the ownership of property. This enables developers to create markets, store registries of debts or promises, move funds in accordance with instructions given long in the past (like a will or a futures contract) and many other things that have not been invented yet, all without a middleman or counterparty risk. This Ethereum blockchain was developed by the Ethereum Foundation: (https://ethereum.io/). But other blockchains can be utilized if they are deemed to be better suited for the dreamr platform.

In the past on traditional server architectures, every application had to set up its own servers that run their own code in isolated silos, making sharing of data hard. If a single app is compromised or goes offline, many users and other apps are affected. However, on a blockchain, anyone can set up a node that replicates the necessary data for all nodes to reach an agreement and be compensated by users and app developers. This allows the user data to remain private and apps to be decentralized.

FIG. 2A is a flow chart showing how a user at a first device is in communication with the dreamr server of FIG. 1. First device 101, in this example, is a mobile phone, smartphone, laptop computer or desktop computer. The first device 101 is a mobile phone may be operating under the IOS app with the operating system if it is an iPhone manufactured by Apple Inc. or it may be operating under the Android app with the operating system if it is an Android phone typically manufactured by Samsung or any other mobile company. The labels first device 101 and the dreamr server 105 are simply indicative of the device that is seeking information and the devices that are providing information. In addition, the use of the singular form is not meant to be limiting; the first device 101 and the dreamr server 105 could be one device or several devices combined into a system or subsystem. Further, a person has downloaded the dreamr software application from the iTunes store, Google Play or any appropriate digital downloading store or service onto the first device 101 to utilize the dreamr software stored on the dreamr server 105.

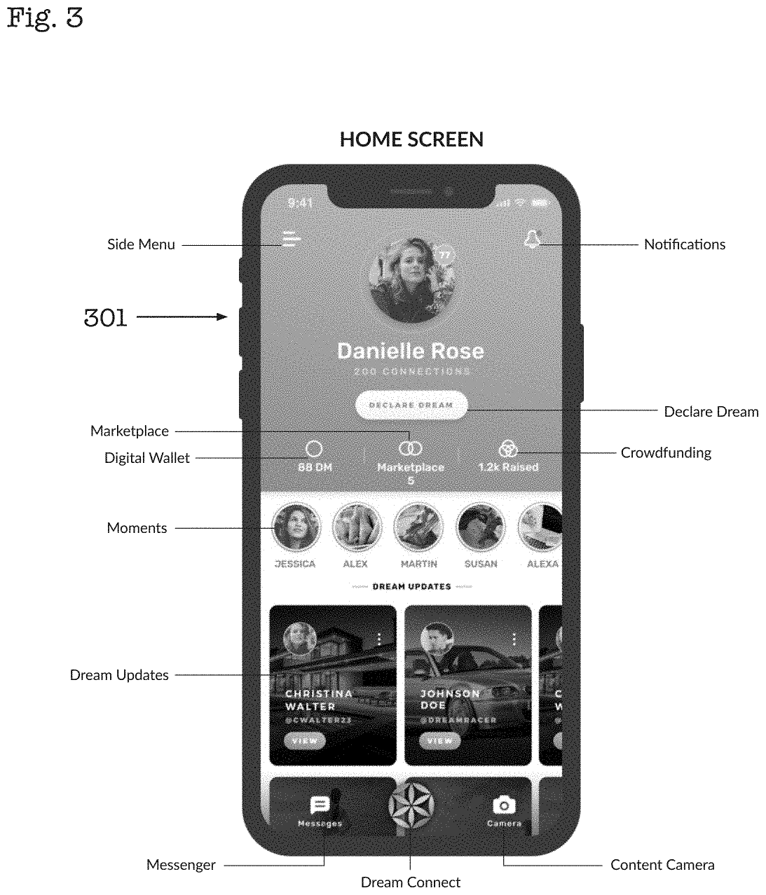

At block 201, a person utilizes first device 101 by clicking on the Dream connect icon to initialize the Dream Connect of the dreamr software application so the person at the first device 101 can access the Home Screen screenshot 301 of the Dreamr Login Page as shown in FIG. 3. First device 101 is connected, as stated above, through the web interface 103 to the dreamr platform 105 which allows first device 101 to access the dreamr software application. This screen shot 301 of the Home Screen includes a side menu Icon, an image of the user Icon, a market place Icon, a Digital Wallet Icon, Declare Dream Icon, Crowdfunding Icon, Moments Icons, Dream updates Icon, a Messenger Icon, a content camera Icon and a Dream Connect Icon utilized to initiate the dreamr software application. Login Page serves as a starting point for accessing information shown on this screen page.

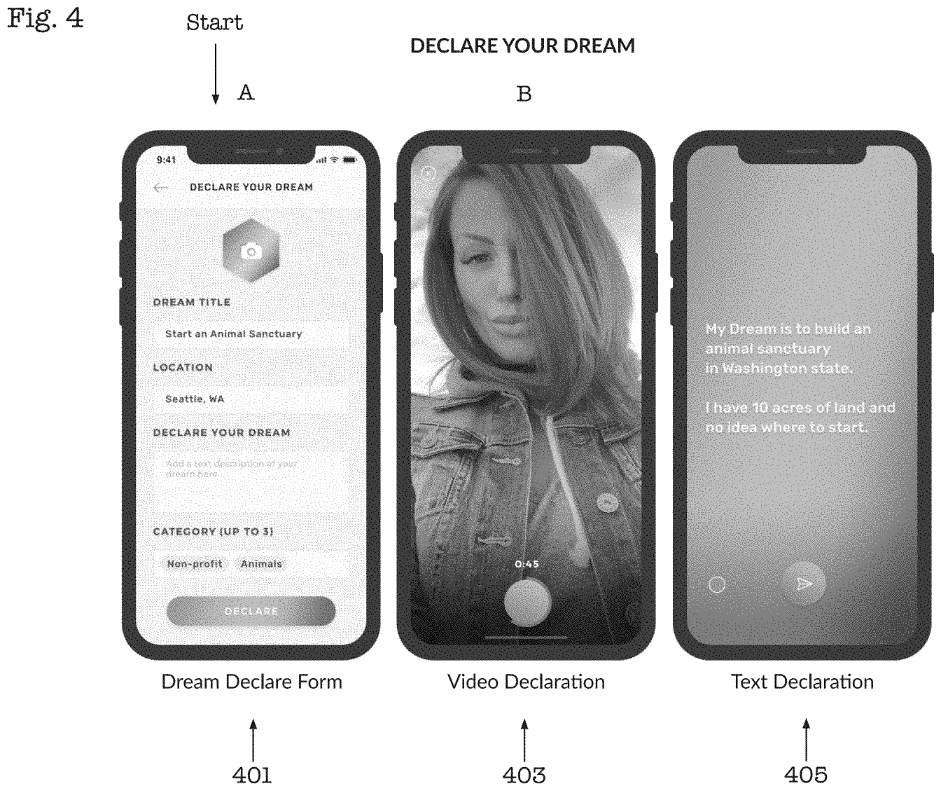

Referring to FIG. 2A, at block 203, the person at the first device 101 determines if she has clicked on the Dream connect icon to declare his/her dream aspiration which moves her/him to Declare Your Dream screen shots shown in FIG. 4. These Declare Dream screenshots 401, 403 and 405 are embedded in the dreamr software application. At FIG. 4, there are 3 screenshots, such as screenshot 401, screenshot 403 and screenshot 405. Referring to FIG. 2A, at block 205, the first device 101 utilizing its input device fills out a form with relevant dream information and is directed to create their Dream Connect slide by creating a video, uploading an image from the camera roll on first device 101 or creating a text slide. The dreams of the first device 101 are tagged with three relevant categories and geo-location for easy discovery in DreamConnect. Screenshot 401 shows a screen that enables first device 101 to Declare your dream where the user can input answers for: Dream Title, Location, Declare your dream and category for dreams. Screenshot 403 shows a screen where first device 101 can upload her/his dream as a video declaration, which can be any length of time in a range of a few seconds to 5 minutes. Screenshot 405 shows a screen where the first device 101 can input his dream via text.

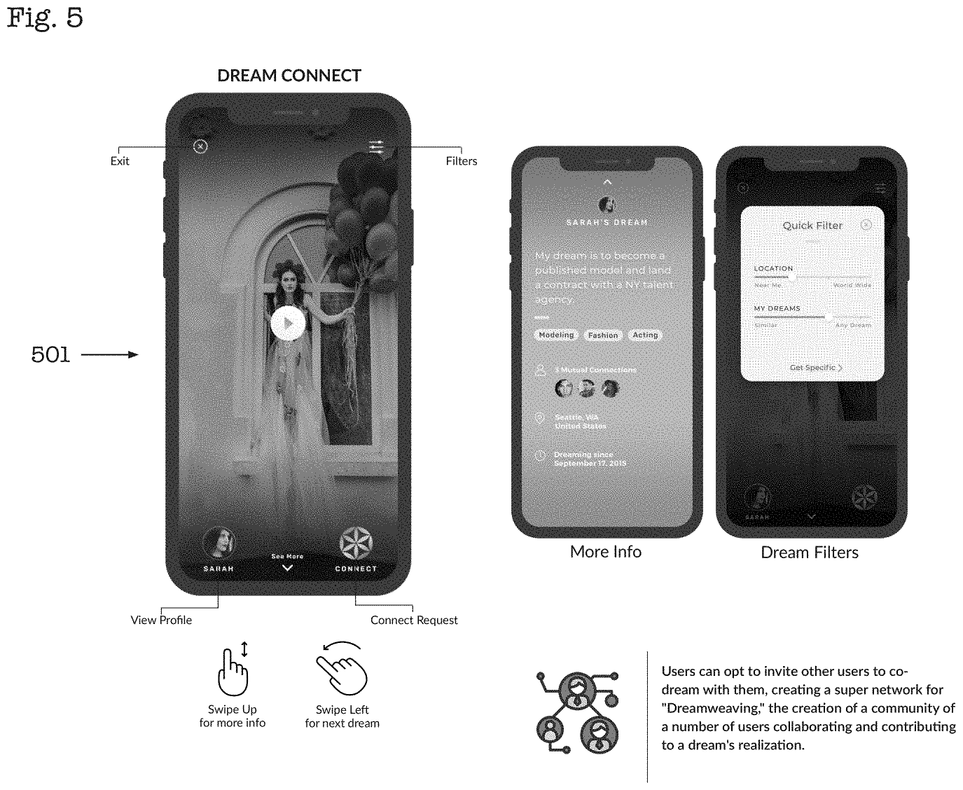

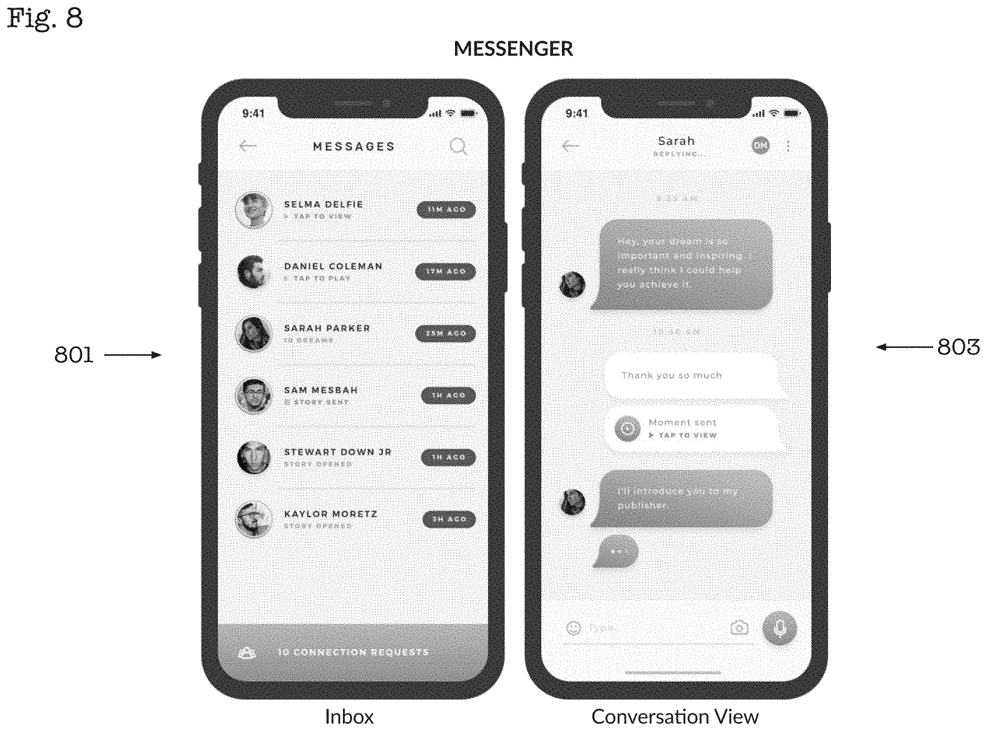

Next, at block 207 dreamr platform makes the dream declared by the first device 101 discoverable by other registered users of the dreamr platform as shown in FIG. 5. FIG. 5 shows a screenshot 501 of a Dream connect that includes a view profile Icon, connect request Icon, exit Icon, filters where a user of the first device 101 can swipe up for more info or swipe left to go to the next dream. A first group of registered dream users or a plurality group of registered dream users tags the content of the dream information inputted by the first device 101 to provide relevant suggestions to registered users daily. Dreamr platform 105 allows the first device 101 to connect to other registered user's dream by the dream of the first device 101 being discoverable and shareable to other registered users. First device 101 will use tags in her/his dreams for geographic location and networking algorithms to give relevant suggested connections. First device 101 can then share her or dream with already established networks on other platforms and have an incentive to do so as they must attain a certain number of corrections on dreamr before being able to attach a crowdfunding campaign to their dream so there is a dream connect. The dreamr software application will host a robust messenger, secured by end-to-end encryption, where after connections are made, the messenger is the most important tool in building new relationships and keeping in touch as shown in FIG. 8. FIG. 8 shows screenshots 801 and 803 of the Messenger. Messenger will include the functionality for: Text, Voice recording, File sharing, Group Chat, Video Chat, P2P payments and camera. Screenshot 801 includes a display of the registered users' messages in an Inbox and screenshot 803 includes a conversation view between various registered users. The entire user experience is centered around starting conversations. A connection from Dream connect comes with a message. User's content generates conversational engagement rather than likes or comments and group chat functionality facilitate community dreaming.

Referring to FIG. 2A, at block 209 the first device 101 along with the other users' dream must determine if they want to invite a second group of registered users to form a supportive network. If no, then the process ends. If yes, there is a determination to co-dream then the dream of first device 101, the first registered users and a second group of registered of users are combined to form a supportive network as in block 211.

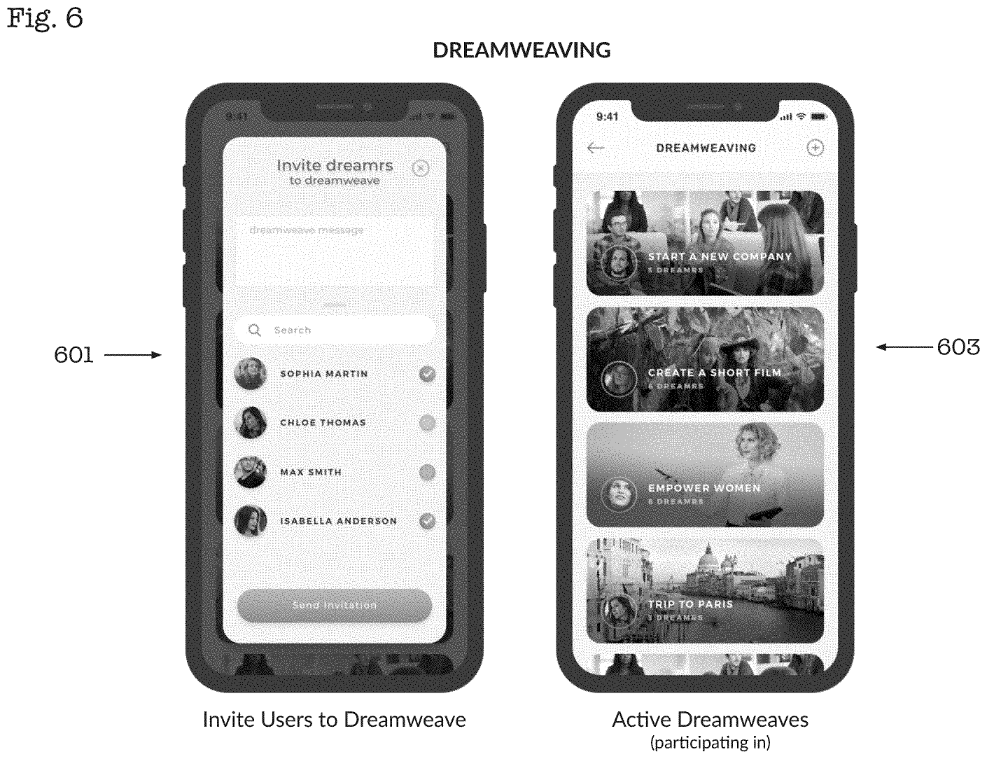

Referring to FIG. 2B, there is a continuation of the flow-chart described in FIG. 2A where at block 213, the first device 101 and the registered users as the supportive network must determine if she/he wants to invite other registered users to co-dream with them. If the supportive network decides not to co-dream, then the process ends. However, if the supportive network does decide to co-dream with other registered users then the process of dreamweaving occurs at block 215 as shown in FIG. 6 to form a supernetwork. The supernetwork along with other registered users can collaborate on content to reach a larger audience and receive extra awareness when launching a crowdfunding campaign. Dreamweaving as shown in the screenshot 601 and 603 of FIG. 6, where screenshot 601 shows an invite for users to dreamweave and screenshot 603 shows users actively dreamweaving. Dreamweaving allows users to form communities to rally around big dreams and collectively contribute to each other's success. While users can only have one declared dream at a time, they can participate in any as many dreamweavers as they desire.

When a super network is formed as shown in FIG. 6, the super-network can collaborate on content to reach a larger audience and receive extra awareness to launch a crowdfunding campaign as an optional process.

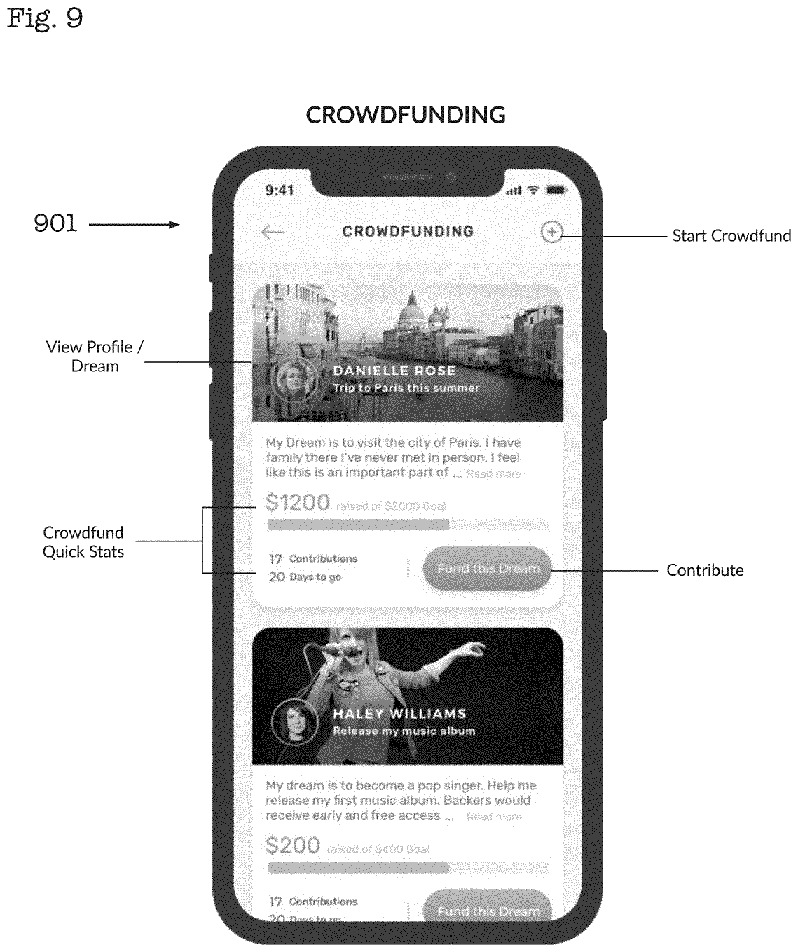

The crowdfunding may occur when the supernetwork reaches a certain threshold of designated milestones based on their number of connections and reputation score indicating they are active within the community, they will become eligible to attach a crowdfunding campaign to their dream as shown in FIG. 9. FIG. 9 is a screenshot 901 of Crowdfunding. Screenshot 901 includes: a View Profile/dream Icon, Start to Crowdfund Icon, Crowdfund Quick Stats Icon and Contribute Icon.

Here are a few crowdfunding examples of how crowdfunding may be utilized on the dreamr device 105 with the dreamr software application. First, Candice is a 20-year-old female that lives in the United States. Candice is an artist and is paying her way through college by selling her artwork and teaching classes on the weekends. She was born in Brazil, but her parents migrated to the US when she was 2 years old. Her dream is to travel to Brazil and meet her extended family in person for the first time. She declares her dream on the dreamr web application and begins to make like-minded connections including: experienced travelers, college students who travel the world with no income, Brazilian natives who tell her about all the fun things to do in her homeland. She now has a good idea of the necessary steps to take and how much money she needs to save to have an enjoyable, two-week trip. She decided to launch a crowdfunding campaign to raise $2,000 USD for her dream trip. The platform lets her know that she'll need at least 250 connections and 300 passion points to launch the campaign. She meets the criteria by forming more connections through Dream Connect and assisting others with their dreams by offering advice and services related to her artistic talent. Next, there is Charles who utilizes the dreamr web application as an inventor and drone enthusiast. He spends his free time building custom drone prototypes and has been awarded several patents for his unique designs. His dream is to start his own drone company and produce his custom drones for sale to the public. After declaring his dream on the dreamr platform, Charles meets new connections that align with his dream. He connects with successful business owners who offer advice on how best to set up his new company and introduce him to several legal firms. He connects with people who share his love of drones and are asking to purchase his custom drones. He also connects with artists and marketers who he invites to co-dream (dreamweave) with him to bring his new company to life. After doing the necessary research, Charles decides to run a crowdfunding campaign for $150,000 to start his new company and produce his custom drones. He decided to offer a compliant token that represents 1 drone for a purchase price of $350, and other smaller rewards for lesser amounts. The dreamr platform notifies him that he needs 2,000 connections and 1,500 passion points to launch the campaign. His supernetwork of 5 people already has the necessary connections and passion points required, and the campaign is approved. These and other examples of how crowdfunding is utilized discloses how the dreamr platform provides a technological solution to a problem that helps to improve the lives of its users.

Campaigns will be governed by smart contracts and be programmable by users through the user interface. Terms will be listed transparently and confirmed by participants. Initially, crowdfunding campaigns will be donation/rewards based, with possible expansion into other formats in the future. The dreamr software application is an innovative invention that provides a technological solution to solving a problem of being able to utilize dreams to form an ecosystem where the dreams can be combined then possibly monetized or crowdfunded. This software provides a unique solution that enables people all over the world to connect through a social network to share their dreams with each other where the dreams can be combined to be utilized to be monetized or crowdfunded.

This dreamr software application will work to become a registered funding portal with the United States SEC and FINRA, which will allow users of the dreamr platform to offer tokenized securities to backers in exchange for their investment under Regulation CF or Regulation A. For example: A drone hobbyist could for a company and mass produce a custom drone prototype. She could offer a branded token to crowdfund participants that is redeemable for the product itself at launch or represent equity in the new company.

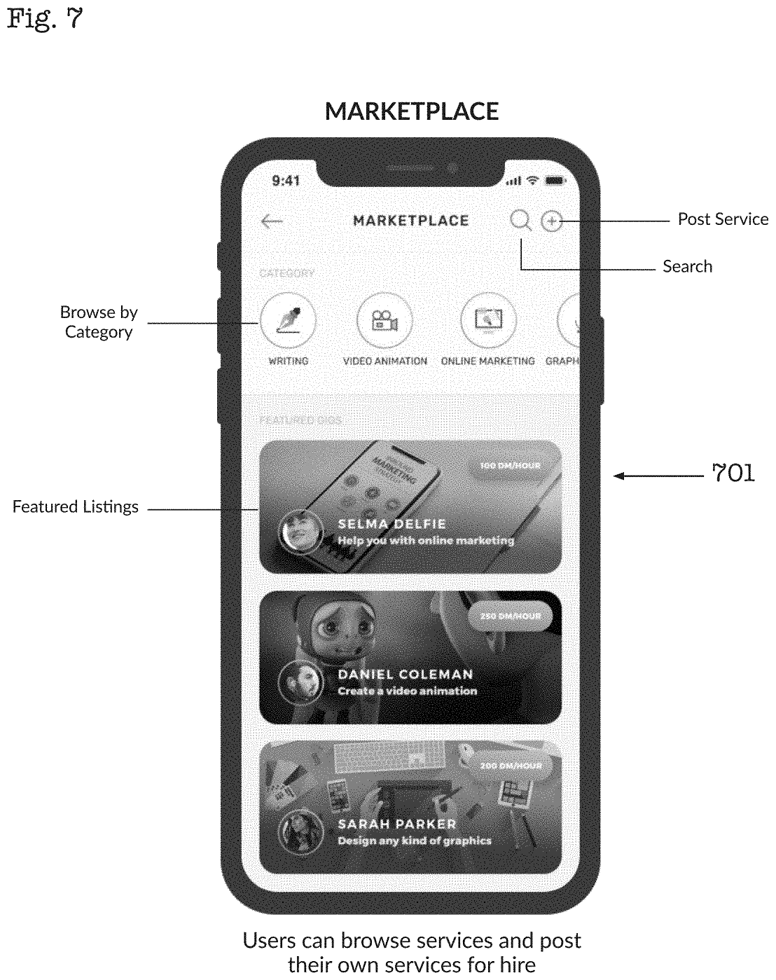

Next at block 217, the first device 101 along with the supernetwork and the other registered users are directed to go to a marketplace site (FIG. 7) to sell his/her goods to monetize themselves in a way that is self-empowering and promotes independence. This marketplace provides an innovative way of allowing the first device 101 along with the supernetwork and other registered users to market their goods and services to a peer-to peer-decentralized marketplace built on the IPFS and Ethereum block chain that creates a unique and trusted ecosystem available only to the first device 101, the supernetwork and other registered users.

FIG. 7 shows a screenshot 701 of Marketplace that shows a Browse by category Icon, Featured Listings Icon and Post service Icon. The first device 101 along with the supernetwork and other registered users can browse services and post their own services for hire. There is a two-prong approach to this end goal that involves the selling of the first device 101 along with the supernetwork and the other registered users defined services. Within the dreamr server 105, there is a connection through the web interface to a peer-to peer decentralized marketplace built on the IPFS system or Ethereum block chain (FIG. 1). First device 101, the supernetwork and other registered users are able to list their skills and services at block 219 for a set price and accept approved cryptocurrencies at the marketplace after it is determined if the payment is acceptable in block 221. If the payment is not acceptable then the process ends. If the payment is acceptable then the goods and services are processed, at block 223, through the process established IPFS or Ethereum block chain system then the process ends at block 225. Supernetworks (dreamweaves) display content or crowdfunding campaigns to the entirety of the network (all individual networks combined). With the original user, such as first device 101, who started the dream having admin control.

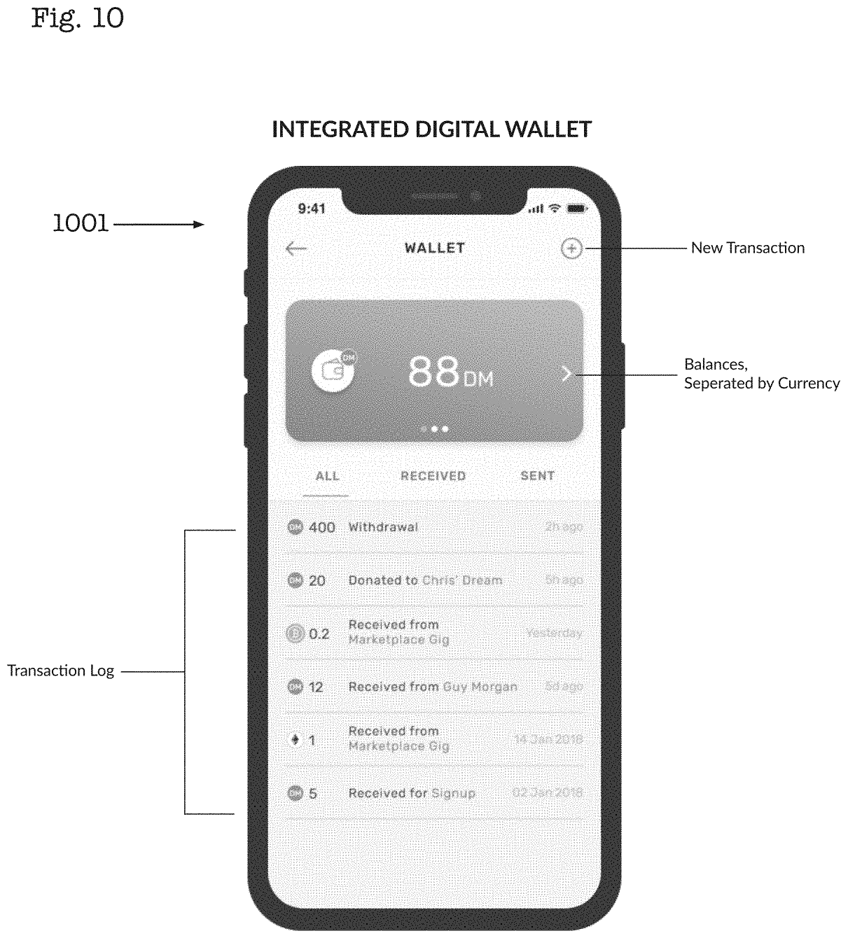

In order to make a payment, this dreamr software application will utilize both fiat and cryptocurrencies where the dreamer software application will house a secure digital wallet for users to manage their fiat balances and cryptocurrencies shown in FIG. 10. FIG. 10 shows a screenshot 1001 of an Integrated Digital Wallet that includes a Transaction log Icon, New Transaction Icon and Balances Icon separated by Currency. The users will be able to: 1. Send fiat and Cryptocurrency peer to peer with no fees; 2. Donate fiat and cryptocurrencies to an ongoing crowdfunding campaign and 3. Use fiat and cryptocurrencies to purchase services in the marketplace and in the dreamr store.

This invention provides a simple innovative for a user to share her dreams with other dreamers, where the dreamers can further enhance her dreams and connect with other dreamers to enhance their dreams. The user is also able to monetize her dreams to sell his goods or skills through a secure digital wallet system.

Although the present invention has been described above in terms of specific embodiments, many modifications and variations of this invention can be made as will be obvious to those of ordinary skill in the art, without departing from its spirit and scope as set forth in the following claims.

What is claimed is:

1. A computer implemented method of communicating between devices, comprising:
transmitting at least one dream request to a specialized program on a dreamr server;
receiving the at least one dream request at the dreamr server;
determining if the at least one dream request invites a first group of registered users to co-dream with the at least one dream request;
forming a supportive network if the at least one dream request invites the first group of registered users;
determining if the supportive network invites a second group of registered users to co-dream;
initiating dreamweaving between the supportive network and the second group of registered users if the supportive network invites the second group of registered users to co-dream and become a supernetwork, effectively combining the two networks into one; and
enabling the supernetwork to become monetized, wherein goods and services of the supernetwork and the other registered users are marketed at a marketplace, and a crowdfunding campaign can be run for the dream request which will be marketed directly to all users belonging to the supernetwork.

2. The method of claim 1, further comprising determining if a payment for the goods and services of the supernetwork and the second group of registered users is accepted.

3. The method of claim 2, further comprising processing the payment through a decentralized marketplace.

4. The method of claim 3 wherein the decentralized marketplace includes an IPFS and an Ethereum block chain system.
